(19) United States
(12) Patent Application Publication
(10) Pub. No.: US 2008/0185871 A1
(43) Pub. Date: Aug. 7, 2008

(54) Vehicle hood apparatus

(75) Inventors: Yasuki Ishiyama, Toyota-shi (JP); Takanobu Toritani, Nagoya-shi (JP); Kensuke Fukuda, Anjo-shi (JP); Takashi Ito, Nishikamo-gun (JP); Katsuhiro Suzuki, Anjo-shi (JP)

Correspondence Address: BIRCH STEWART KOLASCH & BIRCH, PO BOX 747, FALLS CHURCH, VA, 22040-0747, US

(73) Assignee: Mitsubishi Jidosha Engineering Kabushiki Kaisha

(21) Appl. No.: 12/007,340

(22) Filed: Jan. 9, 2008

(30) Foreign Application Priority Data
Feb. 7, 2007 (JP) 2007-027687

(51) Int. Cl. B60R 21/34

(52) U.S. Cl. 296/187.04

(57) ABSTRACT

A bracket extending in a vehicle-width direction is installed in between an outer panel and an inner panel in the rear area of a front hood.

### BACKGROUND OF THE INVENTION

1. Field of the Invention

The present invention relates to a vehicle hood apparatus, and more specifically, to a pedestrian protection technology employed on vehicle hoods.

2. Description of the Related Art

A vehicle that has lately been developed is provided with a hood fabricated in an impact-absorbing structure in case of a vehicle-pedestrian crash, and is therefore capable of absorbing an impact applied to the pedestrian during the collision with the hood.

A well-known impact-absorbing structure includes reinforcing members that are arranged in between outer and inner panels forming a hood, for example, adjacently to both right and left ends of the vehicle hood, extending in a vehicle longitudinal direction (see Unexamined Japanese Patent Publication No. 2005-247262).

However, the structure having the reinforcing members adjacent to the right and left ends of the hood cannot reduce a crash impact if a pedestrian hits the rear area of the hood. Under the rear area of the hood, there is disposed a stiff body framework member such as an upper frame, and due to appearance and structural constraints, it is difficult to secure a sufficient clearance between the hood and the framework member. Therefore, if colliding with the rear area of the hood, the pedestrian contacts the framework member through the hood while relatively high impact energy is sustained. This increases the severity of the impact (injury level) applied to the pedestrian. Especially in recent years, aluminum is used to fabricate hoods of more and more vehicles for the purpose of lightening the vehicles. The hoods made of aluminum are prone to be deformed, as compared to conventional ones made of steel. Consequently, a concern has been raised that the above-mentioned problem may become critical.

Injury levels are determined by where in the hood the pedestrian hits, because of difference in shape of the components lying under the hood, including the upper frame and the engine, and the layout of these components. If the hood has a structure in which reinforcing members are joined to outer and inner panels of the hood as seen in the above-mentioned publication, the hood cannot be designed on the basis of injury levels that vary depending on where the pedestrian hits.

### SUMMARY OF THE INVENTION

The invention has been made to solve the above problems. It is an object of the invention to provide a hood apparatus capable of reducing injury levels by efficiently absorbing impact energy in a rear area of a hood, under which stiff components are located.

In order to achieve the above-mentioned object, the hood apparatus according to the invention is a vehicle hood apparatus fabricated from outer and inner panels. The apparatus has an impact absorbing member extending in the vehicle-width direction, which includes a lower face joined to the inner panel, a wall that extends upward from the lower face, and an upper face extending from an upper edge of the wall in a vehicle longitudinal direction, the impact absorbing member being located in between the outer and inner panels in the rear area of the hood.

A further scope of applicability of the present invention will become apparent from the detailed description given hereinafter. However, it should be understood that the detailed description and specific example, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a perspective view of a vehicle having a hood apparatus according to the present invention;

FIG. 2 is a top view of a front section of the vehicle having the hood apparatus according to the present invention;

FIG. 3 is a top view of an inner panel of a front hood;

FIG. 4 is a sectional view, taken along line A-A of FIG. 2;

FIG. 5 is a perspective view of a bracket; and

FIG. 6 is a graph showing results a pedestrian head protection performance test that is conducted using the hood apparatus of the invention and a hood apparatus without a bracket.

### DETAILED DESCRIPTION OF THE PREFERRED EMBODIMENTS

An embodiment of the present invention will be described below with reference to the attached drawings.

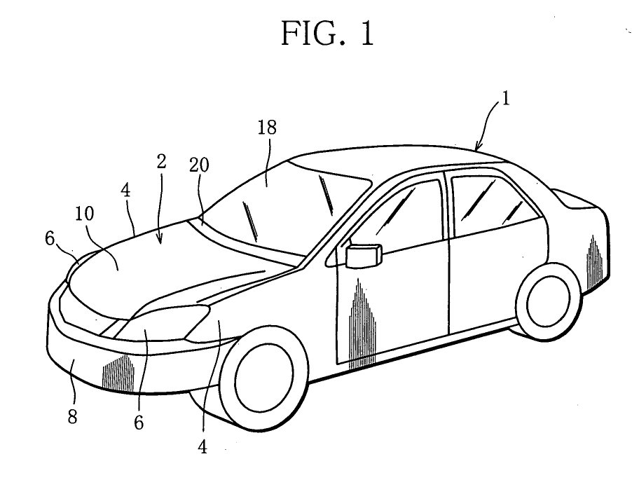

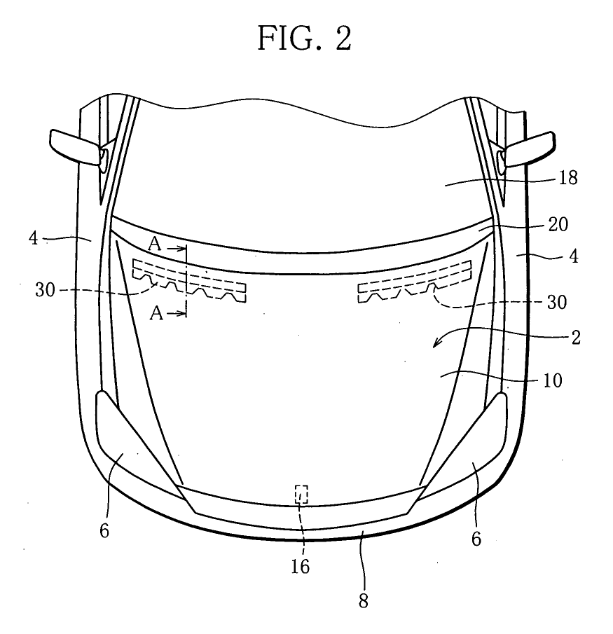

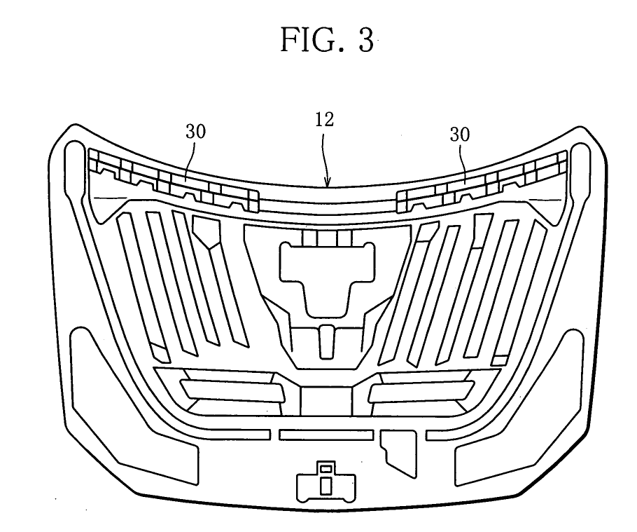

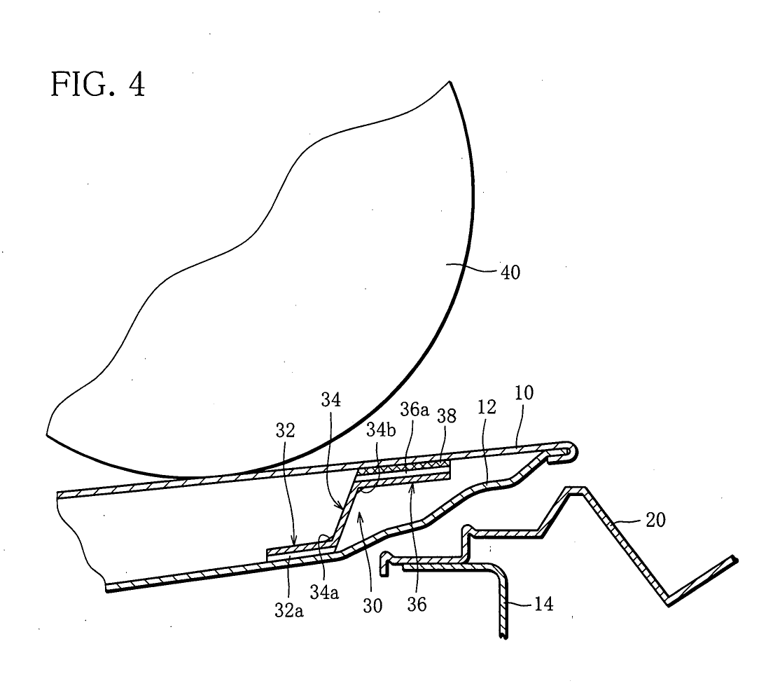

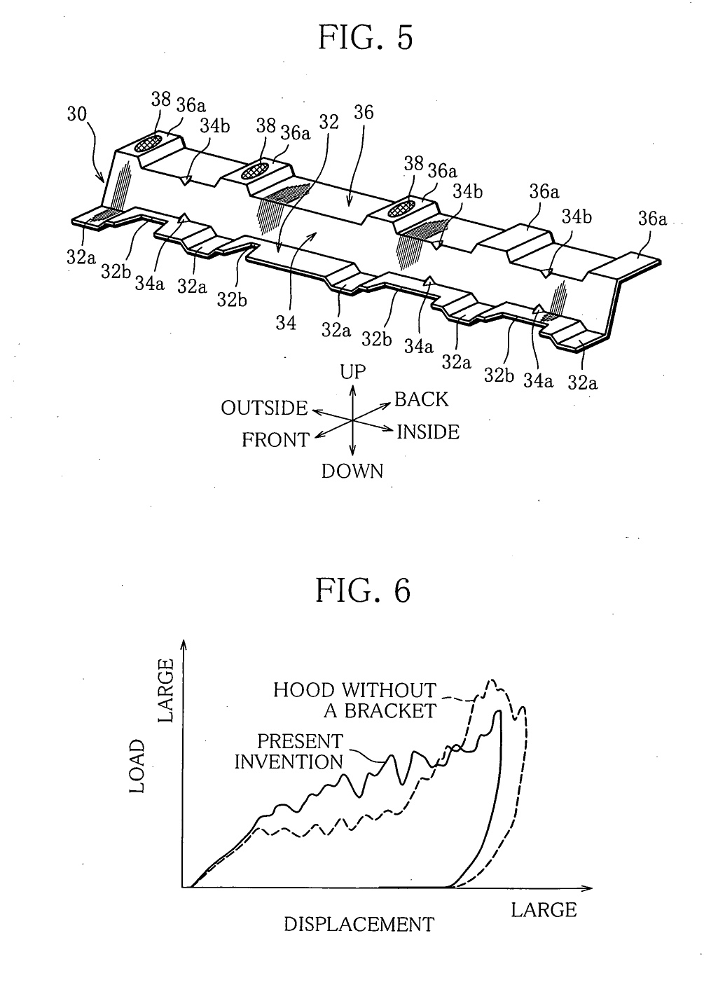

FIG. 1 is a perspective view of a vehicle having a hood apparatus according to the invention. FIG. 2 is a top view showing a front section of the vehicle having the hood apparatus according to the invention. FIG. 3 is a top view of an inner panel of a front hood. FIG. 4 is a sectional view, taken along line A-A of FIG. 2. FIG. 5 is a perspective view of a bracket. The embodiment will be described with reference to FIGS. 1 to 5.

An openable and closable front hood (hood) 2 is disposed above an engine room formed in the front section of a vehicle 1. Front fenders 4 are arranged in both lateral surfaces of the front section of the vehicle 1. A pair of head lights 6 is fixed to both sides of a front end of the vehicle body, and a front bumper 8 extending in a vehicle width direction is fixed under the head lights 6.

The front hood 2 is fabricated from an outer panel 10 serving as an upper face and an inner panel 12 as a lower face.

More specifically, the front hood 2, namely the outer and inner panels 10 and 12, are made of aluminum for lightening of the vehicle.

The outer panel 10 has a shape of a virtually flat plate. The inner panel 12 includes apertures and contours to maintain strength and to produce clearances between the panel 12 and components installed in the engine room.

The outer panel 10 and the inner panel 12 are superposed upon each other at outer circumferential areas and joined together by hemming, riveting, bolting, welding or adhesion with adhesive agent such as resin, to thereby have a closed sectional structure.

The front hood 2 has hinge mechanisms, not shown, on both sides of a trailing edge of the inner panel 12. The front hood 2 is attached to an upper frame 14 that is a framework member of the vehicle 1 through the hinge mechanisms. A striker 16 is set in the center of the front end of the front hood 2, and is fastened by a latch, not shown, disposed in an upper portion of the front bumper 8.

The upper frame 14 is attached to a lower side of a windshield 18 of the vehicle 1, and is disposed under a rear-side area of the front hood 2 to extend in the vehicle-width direction. Under the rear-side area of the front hood 2, there is also a deck garnish 20 so as to cover the upper frame 14.

Brackets (impact-absorbing member) 30 are arranged on both sides of the rear-side area of the front hood 2 to extend in a virtually vehicle-width direction. The right and left brackets 30 have the same functions. The functions will be described below with reference to the right bracket 30.

The bracket 30 has a substantially crank-like sectional shape including a lower face 32 that is directly jointed to the inner panel 12, a wall 34 extending upward from a trailing edge of the lower face 32 and slanted rearward as viewed in a vehicle longitudinal direction, and an upper face 36 extending rearward from an upper edge of the wall 34.

To be concrete, the lower face 32 is provided in five given places two of which are located at both ends of the lower face 32 with lower bead portions 32a bulging downward and extending in the longitudinal direction. In four given places of the lower face 32, apart from the five places in which the lower bead portions 32a are formed, there are cutout portions 32b produced by indenting the front edge of the lower face 32 in the rearward direction. The lower bead portions 32a of the lower face 32 contact the inner panel 12 and is fixed by spot welding.

In a boundary, or bent area, between the lower face 32 and the wall 34 and that between the wall 34 and the upper face 36, there are formed three springback-preventing reinforcing portions 34a and three springback-preventing reinforcing portions 34b, respectively, each protruding into an inner angle in a tetrahedral shape.

In the upper face 36 of the bracket 30, there are formed five upper bead portions 36a bulging upward and extending in the longitudinal direction so as to conform to the lower bead portions 32a.

Three of the upper bead portions 36a, which are located outermost as viewed in the vehicle-width direction, are applied with sealant 38 in upper surfaces thereof. These three upper bead portions 36a are joined to the outer panel 10 with the sealant 38.

If the upper bead portions 36a are made to conform to the lower bead portions 32a, this enhances impact absorption performance exerted in between the outer panel 10 and the inner panel 12.

The upper bead portions 36a of the upper face 36, the lower bead portions 32a of the lower face 32, and the reinforcing portions 34a are formed in relatively stiff areas of the upper frame 14 and the deck garnish 20 located under the front hood 2 and in areas at short distance to the front hood 2. The three of the upper bead portions 36a, which are joined to the outer panel 10 with the sealant 38 are located in the stiffest areas of the upper frame 14 and the deck garnish 20 and in the areas at short distance to the hood 2.

The cutout portions 32b of the lower face 32 are situated in the upper frame 14 and the deck garnish 20 to be located in areas relatively low in stiffness and areas distant from the front hood 2.

Operation of the vehicle hood apparatus thus constructed will be described below.

FIG. 6 is a graph showing results of a pedestrian head protection performance test that is conducted using the hood apparatus of the invention and a hood apparatus without a bracket. Descriptions will be provided below with reference to FIGS. 4 and 6.

The pedestrian head protection performance test, the results of which are shown in FIG. 6, was conducted under the condition that the vehicle 1 hits a pedestrian, and the pedestrian's head crashes into the front hood 2. In the test, a head impactor 40 imitating a human head is launched at a given position of the front hood 2 from above as shown in FIG. 4, to thereby measure an impact applied to the head impactor 40 and gauge head-injury levels. The result graph of FIG. 6 is obtained under the situation that the head impactor 40 collides with the front hood 2 at the position conforming to A-A line of FIG. 2, that is, the rear area of the front hood 2. A horizontal axis shows displacement of the head impactor from a time point of the collision, and a vertical axis shows the load applied to the head impactor.

In the hood apparatus according to the invention, when the head impactor 40 collides with the rear area of the front hood 2, the outer panel 10 is deformed and contacts the bracket 30 because of the bracket 30 placed in between the outer panel 10 and the inner panel 12.

As a result, deformation load is generated in the outer panel 10, the bracket 30, and the inner panel 12, thereby sufficiently absorbing the impact energy of the collision.

The deformation load is generated in the upper bead portions 36a earlier than in the other area of the upper surface 36 of the bracket 30. Especially in the area where the upper bead portions 36a and the outer panel 10 are joined together, the deformation load is generated at the same time as the collision.

The bracket 30 is formed to have the substantially crank-like sectional shape that is virtually perpendicular to input applied from the direction that the pedestrian crashes into the front hood 2 in a front crash, that is, from front or from above the front hood 2. Therefore, the bracket 30 can be easily deformed by impact, so that the deformation load is not rapidly increased.

If the brackets 30 are not provided to the front hood 2, the impact energy of the head impactor 40 is absorbed only by the deformation load of the outer panel 10 in an early stage of the deformation.

As shown in FIG. 6, in the case of the hood apparatus of the invention which is shown by a slid line, the head impactor 40 receives high load from the early stage of the deformation. In contrast, in the case of the hood apparatus without a bracket which is shown by a broken line, the load applied to the head impactor 40 from the early stage through a middle stage of the deformation is low.

According to the hood apparatus of the invention, in and after the middle stage of the deformation, that is, the stage where the front hood 2 contact the deck garnish 20 and the upper frame 14, even if the bracket 30 is in a flat state, as long as the lower face 32 and the upper face 36 are joined to the inner panel 12 and the outer panel 10, respectively, load is produced as the bracket 30 is pulled. This also absorbs the impact energy.

Since the impact energy is sufficiently absorbed before the middle stage of the deformation, the load applied to the head impactor 40 is not drastically increased, and the head impactor 40 is suppressed from being displaced.

Without a bracket, the head impactor 40 collides with the stiff upper frame 14 and deck garnish 20 while maintaining the relatively high impact energy. As a result, the load applied to the head impactor 40 is rapidly increased, and the displacement of the head impactor 40 is large, which incurs a high injury level.

According to the hood apparatus of the invention, the brackets 30 are placed in the inside of the rear area of the front hood 2. Therefore, if the pedestrian collides with the rear area of the front hood 2, the impact energy can be sufficiently absorbed by creating the deformation load of the outer panel 10, the brackets 30 and the inner panel 12 from the early stage of the deformation. Consequently, the injury level is reduced.

To form the upper bead portions 36a, the lower bead portions 32a and the reinforcing portions 34a in the brackets 30 improves the stiffness of each area and enhances the deformation load. This also makes it possible to sufficiently absorb the impact energy.

The upper bead portions 36a, the upper and lower bead portions 36a and 32a jointed together with the sealant 38, the reinforcing portions 34a, and the cutout portions 32b are positioned according to the stiffness of the upper frame 14 and the deck garnish 20 located below and the distance from the upper frame 14 and the deck garnish 20 to the front hood 2. This allows to set the deformation load suitable to each area of the front hood 2 and to efficiently reduce the injury level.

This is the end of the description of the embodiment of the vehicle hood apparatus according to the invention. The invention, however, is not limited to the above-described embodiments.

For example, the bracket 30 is formed to have the substantially crank-like sectional shape in which the wall 34 extends upward from the trailing edge of the lower face 32 and is slanted rearward as viewed in the vehicle longitudinal direction, and an upper face 36 extends rearward from an upper edge of the wall 34. The sectional shape of the bracket 30 is not limited to the substantially crank-like shape. For example, the bracket 30 may have a substantially Z-like sectional shape formed of a wall extending upward from the leading edge of the lower face and slanted rearward, and an upper face extending forward from the upper edge of the wall.

According to the embodiment, the brackets 30 are placed to both sides of the hood as viewed in the vehicle-width direction. However, the configuration of the brackets is not limited to this, and it is possible to provide one bracket extending from one end to the other across the width of the hood.

Although the front hood 2 is made of aluminum in the embodiment, the material of the front hood is not limited to aluminum. For example, the material of the front hood may include steel.

According to the embodiment, the upper frame 14 and the deck garnish 20 are installed under the rear area of the front hood, but the configuration is not limited to this. Another component may be installed as well.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A vehicle hood apparatus formed of an outer panel and an inner panel, comprising:
an impact absorbing member extending in a vehicle-width direction, which includes a lower face joined to the inner panel, a wall that extends upward from the lower face, and an upper face extending from an upper edge of the wall in a vehicle longitudinal direction, the impact absorbing member being located in between the outer and inner panels in the rear area of the hood.

2. The vehicle hood apparatus according to claim 1, wherein:
upper bead portions bulging upward are formed in given positions of the upper face of the impact absorbing member.

3. The vehicle hood apparatus according to claim 2, wherein:
prescribed upper bead portions among the upper bead portions are applied with sealant at upper surfaces thereof, and are joined to the outer panel with the sealant.

4. The vehicle hood apparatus according to claim 2, wherein:
lower bead portions bulging downward are formed in positions of the lower surface of the impact absorbing member, which conform to the upper bead portions, and the lower bead portions are joined to the inner panel.

5. The vehicle hood apparatus according to claim 1, wherein:
the impact absorbing member is formed to have a substantially crank-like sectional shape in which the wall extends upward from one of leading and trailing edges of the lower face, and the upper face extends from the upper edge of the wall in the opposite direction to the lower face with the wall interposed between the upper and lower faces.

6. The vehicle hood apparatus according to claim 5, wherein:
the impact absorbing member is formed to have a substantially crank-like sectional shape in which the wall extends upward from the trailing edge of the lower face, and the upper face extends rearward from the upper edge of the wall.

7. The vehicle hood apparatus according to claim 1, wherein:
the wall is formed as an inclined face that is slanted rearward from the lower face.
